(19) United States
(12) Patent Application Publication
(10) Pub. No.: US 2008/0206581 A1
(43) Pub. Date: Aug. 28, 2008

(54) Static-Electricity Proof Tile

(76) Inventor: Moon-Soo Lee, Seoul (KR)

Correspondence Address: BOOTH UDALL, PLC, 1155 W. Rio Salado Pkwy., Suite 101, Tempe, AZ, 85281, US

(21) Appl. No.: 11/912,610

(22) PCT Filed: Jun. 22, 2005
(86) PCT No.: PCT/KR05/01931

§ 371 Date: Oct. 25, 2007

(30) Foreign Application Priority Data
Apr. 25, 2005 (KR) 10-2005-0033869

(51) Int. Cl. B32B 15/088; B32B 15/09

(52) U.S. Cl. 428/458

(57) ABSTRACT

Disclosed is static electricity proof tile, which has volume resistance lower than conventional tiles, prevents bleeding, which typically occurs in static electricity proof tiles manufactured using a surfactant, blocks electronic waves and water vein waves, and has an excellent moisturization function. The static electricity proof tile (100) according to this invention includes an upper layer (10) and a lower layer (20) provided beneath the upper layer (10) and formed of synthetic resin material containing a surfactant, in which a barrier means (50) is interposed between the upper layer (10) and the lower layer (20) for preventing bleeding of the surfactant. Further, the static electricity proof tile can have volume resistance decreased to 10⁶-10¹⁰, compared to conventional static electricity proof tiles, can prevent bleeding of the surfactant contained in the lower layer formed of synthetic resin material and also separation of the tile due to bleeding of the surfactant, and can block electronic waves and water vein waves.

### TECHNICAL FIELD

The present invention relates to static electricity proof tile. The present invention provides static electricity proof tile, which has volume resistance lower than conventional tiles, prevents bleeding, which typically occurs in static electricity proof tiles manufactured using a surfactant, prevents the separation of layers thereof due to the bleeding of the surfactant, blocks electronic waves and water vein waves, and has an excellent moisturization function.

The static electricity proof tile according to the present invention is applied on floors of fabrication and assembly lines of semiconductors and other electronic and electric products, laboratory rooms, clean rooms, floors of operating rooms of hospitals, and floors of offices suffering from harmful electronic waves, thus absorbing or shunting static electricity.

### BACKGROUND ART

In general, tiles (which are referred to as ‘mats’ or ‘sheets’, and hereinafter simply as ‘tile’) for prevention of static electricity have been numerously provided. Conventional static electricity proof tile has been manufactured using a process of applying or including conductive metal powder such as copper, gold, or silver on the surface thereof or therein, a process of adding a surfactant upon formation of a sheet, or a process of mixing synthetic resin material or rubber material with carbon before preparation of a mat.

Conventionally, as the static electricity proof tile using carbon, not only general carbon tile, obtained by mixing synthetic resin material with carbon and then roll-compressing it into the shape of tile, but also those disclosed in Korean Utility Model Nos. 1987-2585 and 97-732 are exemplary.

In the Utility Model No. 1987-2585, with the goal of decreasing the amount of carbon to reduce costs, used is a method of forming a mat by applying a carbon layer on synthetic resin particles and then compressing a plurality of the particles in a mold. The Utility Model No. 97-732, which is an improvement of the Utility Model No. 1987-2585, provides a sheet obtained by cutting the conductive tile manufactured according to the Utility Model No. 1987-2585 to a thickness of about 1 mm, forming a middle layer made of PVC synthetic resin beneath the tile, forming a soft rubber sheet beneath the middle layer, and thermally fusing them.

However, the above-mentioned conductive tiles or static electricity proof tiles using carbon have the following problems.

First, in the case where conductive tile is made using the synthetic resin material mixed with carbon, the resultant tile has a very soft surface and thus has limited usefulness as floor material. Particularly, since such tile may be gouged or scratched by the soles of shoes, it is unsuitable for use as floor material.

Second, when the static electricity proof tile, manufactured using the conventional process of mixing synthetic resin material with carbon, is abraded, carbon may adhere on a contacting object, undesirably polluting the contacting object.

Third, the static electricity proof tile, manufactured by coating synthetic resin particles and then pressure forming them, has discontinuous sections of carbon, thereby allowing slight generation of static electricity.

Fourth, the manufacturing process, including coating the synthetic resin particles, is complicated, leading to increased manufacturing cost.

In order to overcome such problems, Korean Patent Laid-open Publication Nos. 2001-44707 (2001 Jun. 5) and 2002-47078 (2002 Jun. 21) disclose static electricity proof tile, filed by and allowed to the present applicant. These patents are characterized in that, in the tile comprising a tile body and a carbon film or a carbon-containing film or carbon coating layer laminated therebeneath, in the case where the carbon film having surface resistance of 10⁶˜10¹² Ω/ [symbol] or less is laminated beneath the transparent film, which is nonconductive, the electric resistance of the surface of the transparent film can be decreased to 10¹⁰˜10¹² Ω/ [symbol] by a tunneling effect, thus preventing the generation of static electricity.

However, the above patents are disadvantageous because it is difficult to actually decrease the surface resistance to 10⁹ Ω/ [symbol] or less, and volume electric resistance of 10¹⁴ Ω/ [symbol] does not change even though the surface electric resistance is decreased as mentioned above, thus the static electricity proof tile is not effective in the prevention of static electricity because it has properties similar to a nonconductor.

Accordingly, although the surface resistance and volume resistance are intended to be decreased by containing a surfactant in the tile body, the use of the surfactant causes bleeding, such that the surface of the tile may be polluted and the layers thereof may be separated.

### DISCLOSURE OF INVENTION

### Technical Problem

Therefore, an object of the present invention is to provide static electricity proof tile, which has volume resistance lower than conventional tiles, prevents bleeding, which typically occurs in static electricity proof tiles manufactured using a surfactant, prevents the separation of layers thereof due to the bleeding of the surfactant, blocks electronic waves and water vein waves, and has an excellent moisturization function.

### Technical Solution

In order to accomplish the above object, the present invention provides static electricity proof tile, comprising an upper layer and a lower layer provided beneath the upper layer and formed of synthetic resin material containing a surfactant, in which a barrier means is interposed between the upper layer and the lower layer for preventing bleeding of the surfactant.

In addition, the present invention provides static electricity proof tile, comprising an upper layer and a lower layer provided beneath the upper layer and formed of synthetic resin material containing a surfactant, in which a barrier means is formed beneath the lower layer for preventing bleeding of the surfactant.

The tile may further comprise a conductive means formed beneath the lower layer or the barrier means.

The conductive means may be any one selected from among a carbon film, a carbon coating film obtained by applying or printing carbon, and a conductive film formed by thermally compressing a carbon-containing film.

The conductive means may be a sheet containing metal or coated with metal, the metal being any one selected from among nickel, copper, silver, potassium, magnesium, cadmium, and aluminum.

The barrier means may be an aluminum sheet, in which a synthetic resin film may be provided on either or both surfaces of the aluminum sheet.

The barrier means may comprise an air impermeable layer formed of polyamide, polyester, EVOH, or nylon, the air impermeable layer containing carbon or metal.

The tile may have surface resistance of 10⁶˜10¹² Ω/ [symbol] and volume resistance of 10⁶˜10¹⁰ Ω/ [symbol] .

### Advantageous Effects

According to the present invention, the static electricity proof tile can have volume resistance decreased to 10⁶˜10¹⁰ [symbol] , compared to conventional static electricity proof tiles. In addition, bleeding of the surfactant contained in the lower layer formed of synthetic resin material does not take place, and thus the separation of the tile can be prevented. Moreover, electronic waves and water vein waves can be blocked.

### BRIEF DESCRIPTION OF THE DRAWINGS

FIG. 1a is an exploded perspective view of the tile according to a first embodiment of the present invention, and FIG. 1b is a sectional view of FIG. 1a; and

FIG. 2a is an exploded perspective view of the tile according to a second embodiment of the present invention, and FIG. 2b is a sectional view of FIG. 2a.

### DESCRIPTION OF THE REFERENCE NUMERALS IN THE DRAWINGS

10: upper layer 12: color printed film

14: transparent film 20: lower layer

22: polyethylene film 30: air impermeable layer

40: conductive means 50: barrier means

52: sheet 54: polyethylene film

60: air impermeable layer 100: static electricity proof tile

### BEST MODE FOR CARRYING OUT THE INVENTION

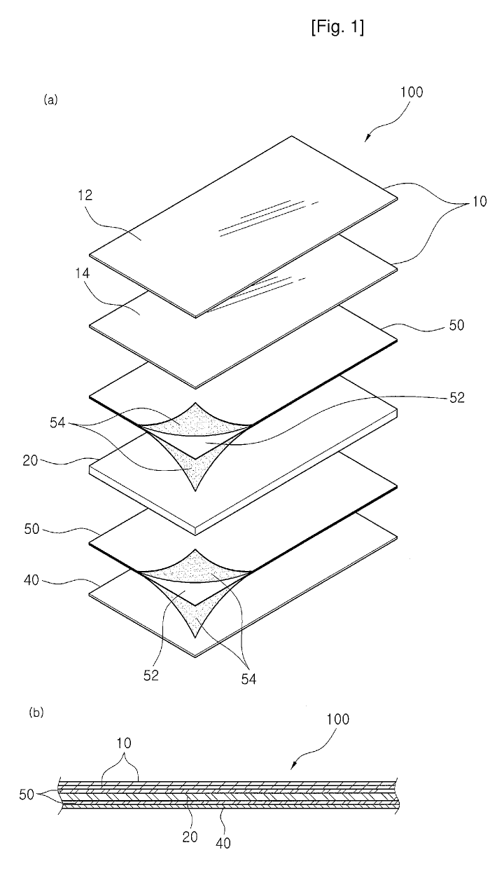

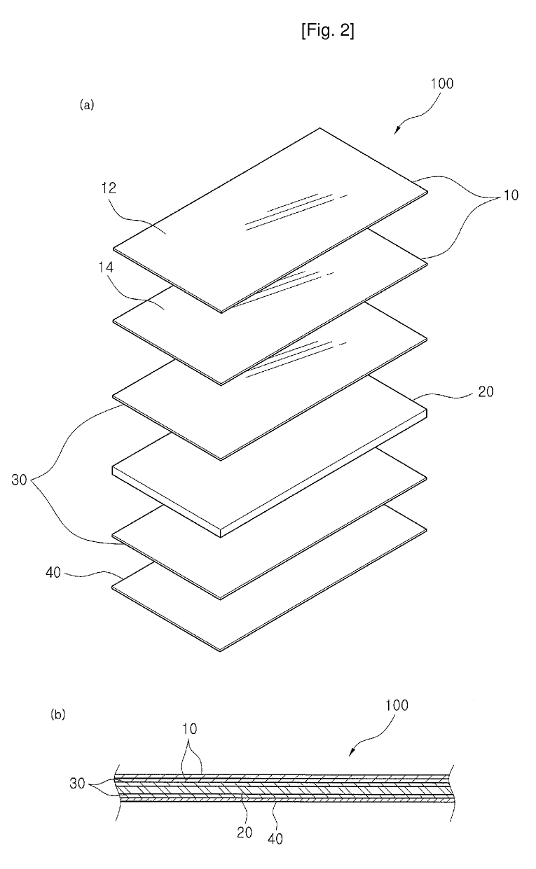

Hereinafter, a detailed description will be given of preferred embodiments of the present invention, with reference to FIGS. 1 and 2.

FIG. 1a is an exploded perspective view of the tile according to a first embodiment of the present invention, and FIG. 1b is a sectional view of FIG. 1a. In addition, FIG. 2a is an exploded perspective view of the tile according to a second embodiment of the present invention, and FIG. 2b is a sectional view of FIG. 2a.

As shown in FIGS. 1a and 1b, the static electricity proof tile 100 according to the present invention comprises an upper layer 10, a lower layer 20 laminated beneath the upper layer 10, a barrier means 50 interposed between the upper layer 10 and the lower layer 20, and a conductive means 40 laminated beneath the lower layer 20.

The upper layer 10 is composed of a transparent film 12 and a color printed film 14 laminated beneath the transparent film 12. The transparent film 12 is formed to a thickness of about 0.3 mm, and the color printed film 14 to a thickness of about 0.1 mm.

The lower layer 20 is preferably formed of synthetic resin material, and more preferably PVC. The lower layer 20 contains a surfactant for decreasing surface resistance and volume resistance of the static electricity proof tile 100. The surfactant is contained at a ratio of 3˜10% relative to the volume of PVC.

Although the surfactant is conventionally contained in PVC, such a surfactant having evaporation properties evaporates and thus the conductivity is deteriorated. Further, while the surfactant evaporates, bleeding, which pollutes the surface of the tile, may take place. Furthermore, separation of the tile may undesirably occur due to the bleeding.

However, in the present invention, in order to prevent bleeding caused by evaporation of the surfactant and separation of the static electricity proof tile 100, the barrier means 50 may be interposed between the upper layer 10 and the lower layer 20, or the barrier means 50 may be provided beneath the lower layer 20.

The barrier means 50 includes a sheet 52 formed of any one selected from among aluminum, nickel, copper, silver, potassium, magnesium, and cadmium, the sheet 52 being preferably formed of aluminum having good ductility. In addition, it is preferred that a polyethylene film 54 be laminated on either or both surfaces of the sheet 52. As such, the polyethylene film 54 functions to easily laminate the upper layer 10 and the lower layer 20.

The barrier means 50 may act to prevent the bleeding of the surfactant. The barrier means 50 may prevent the pollution of the surface of the tile due to the bleeding of the highly volatile surfactant in the lower layer, and also the barrier means 50 functions to prevent permeation of moisture into the lower layer formed of synthetic material.

As shown in FIGS. 2a and 2b, the barrier means 50 may be an air impermeable layer 60 laminated on either or both surfaces of the lower layer 20, the air impermeable layer 60 being made of polyamide, polyester, nylon or EVOH. Preferably, the air impermeable layer 60 may contain carbon or metal.

The air impermeable layer 60 exhibits an effect of preventing the bleeding of the surfactant.

The second embodiment shown in FIGS. 2a and 2b is the same as the first embodiment of FIGS. 1a and 1b, with the exception of the structure of the barrier means.

The conductive means 40 laminated beneath the lower layer 20 may be composed of any one selected from among a carbon film, a carbon coating film obtained by applying or printing carbon, and a conductive film formed by thermally compressing a carbon-containing film. The conductive means 40 functions to increase the conductivity of the tile containing the surfactant and to permanently prevent static electricity.

The static electricity proof tile according to the present invention has surface resistance of 10⁶˜10¹² Ω/ [symbol] and volume resistance of 10⁶˜10¹⁰ Ω/ [symbol] , and thus can block static electricity and electronic waves.

In addition, the barrier means may be attached beneath the lower layer.

### MODE FOR THE INVENTION

A better understanding of the present invention may be obtained in light of the following examples which are set forth to illustrate, but are not to be construed to limit the present invention.

### EXAMPLE 1

### Surface Resistance of Inventive Tile

The lower surface of a lower layer was coated with carbon, as a conductive means 40, and a surfactant was contained in the lower layer at 5% (volume ratio). In addition, an aluminum sheet 52 having upper and lower surfaces coated with polyethylene was interposed between an upper layer 10 and the lower layer 20, after which resistance between electrodes on the same plane was measured. As the result, the surface resistance of the tile was measured to be 10⁸ Ω/ [symbol] , which was lower than the surface resistance of conventional static electricity proof tile 100. Therefore, the tile of the present invention was regarded as effective for the prevention of static electricity and also was confirmed to have the electronic wave blocking effect mentioned below.

### EXAMPLE 2

### Volume Resistance of Inventive Tile

The electrodes of Example 1 were disposed in a thickness direction to measure the resistance of the tile. As the result of evaluation of volume resistance through disposition of the electrodes in a thickness direction, the volume resistance was measured to be 10⁸ Ω/ [symbol] .

Thus, the volume resistance was decreased from 10¹⁴ Ω/ [symbol] to 10⁸ Ω/ [symbol] , such that the tile of the present invention was conductive and could efficiently decrease static electricity.

### EXAMPLE 3

### Test for Blocking Electronic Waves by Inventive Tile

The extent of blocking of the electronic waves by the static electricity proof tile of the present invention was measured. To this end, ASTM D4935-89 was applied, and the resulting decibel value (A) was found to be 8±05 dB.

Subsequently, when the decibel value (A) was substituted for an equation for calculating an electronic wave blocking effect (blocking effect (%)=(1-10^{-A/10})×100%), 82.21˜85.87% of the electronic waves were confirmed to have been blocked.

### EXAMPLE 4

### Test for Blocking Water Vein Waves by Inventive Tile

Water vein waves, which are considered problematic in modern society, were confirmed to have been blocked. Water vein waves are harmful waves emanating from at least 100˜200 m below the surface of the earth. When useful waves are radiated to a position from where the harmful waves emanate, the harmful waves may be naturally cancelled and made powerless. However, scientific equipment for measuring water vein waves has not yet been introduced, and measurement can only be conducted using an L-rod or pendulum, depending on the sensitivity of humans. Thus, whether water vein waves were blocked was measured using a far infrared emission test and a thermal imaging system. According to an FT-IR spectrometer process based on the assumption that the emissivity of a theoretical sample, such as a black body, which does not actually exist, is determined to be 1, the far infrared emissivity of the static electricity proof tile of the present invention was measured to be 0.68, that is, 68%. Further, 250 W of emission energy was produced, thus neutralizing water vein waves.

In addition, the static electricity proof tile according to the present invention was subjected to a thermal imaging test. As the result, since far infrared light at 30° C. was emitted at room temperature of 26° C., water vein waves were confirmed to have been neutralized.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A static electricity proof tile, comprising an upper layer and a lower layer provided beneath the upper layer formed of synthetic resin material containing a surfactant, in which a barrier means is interposed between the upper layer and the lower layer for preventing bleeding of the surfactant.

2. A static electricity proof tile, comprising an upper layer and a lower layer provided beneath the upper layer and formed of synthetic resin material containing surfactant, in which a barrier means is formed beneath the lower layer for preventing bleeding of the surfactant.

3. The tile according to claim 1, further comprising a conductive means formed beneath the lower layer.

4. The tile according to claim 2, further comprising a conductive means formed beneath the barrier means.

5. The tile according to claim 2, wherein the conductive means is any one selected from among a carbon film, a carbon coating film obtained by applying or printing carbon, and a conductive film formed by thermally compressing a carbon-containing film.

6. The tile according to claim 2, wherein the conductive means is a sheet which contains metal or is coated with metal, the metal being any one selected from among nickel, copper, silver, potassium, magnesium, cadmium, and aluminum.

7. The tile according to claim 1, wherein the barrier means is a sheet formed of any one selected from among aluminum, nickel, copper, silver, potassium, magnesium, and cadmium.

8. The tile according to claim 7, wherein the sheet further comprises a synthetic resin film laminated on either or both surfaces thereof.

9. The tile according to claim 1, wherein the barrier means comprises an air impermeable layer formed of polyamide, polyester, EVOH, or nylon.

10. The tile according to claim 9, wherein the air impermeable layer contains carbon or metal.

11. The tile according to claim 1, having surface resistance of 10⁶˜10¹² Ω/□.

12. The tile according to claim 1, having volume resistance of 10⁶˜10¹² Ω/□.

13. The tile according to claim 3, wherein the conductive means is any one selected from among a carbon film, a carbon coating film obtained by applying or printing carbon, and a conductive film formed by thermally compressing a carbon-containing film.

14. The tile according to claim 3, wherein the conductive means is a sheet which contains metal or is coated with metal, the metal being any one selected from among nickel, copper, silver, potassium, magnesium, cadmium, and aluminum.

15. The tile according to claim 2, wherein the barrier means is a sheet formed of any one selected from among aluminum, nickel, copper, silver, potassium, magnesium, and cadmium.

16. The tile according to claim 2, wherein the barrier means comprises an air impermeable layer formed of polyamide, polyester, EVOH, or nylon.

17. The tile according to claim 2, having surface resistance of 10⁶˜10¹² Ω/□.

18. The tile according to claim 3, having surface resistance of 10⁶˜10¹² Ω/□.

19. The tile according to claim 4, having surface resistance of 10⁶˜10¹² Ω/□.

20. The tile according to claim 2, having volume resistance of 10⁶˜10¹² Ω/□.

21. The tile according to claim 3, having volume resistance of 10⁶˜10¹² Ω/□.

22. The tile according to claim 4, having volume resistance of 10⁶˜10¹² Ω/□.
